(19) United States
(12) Patent Application Publication
(10) Pub. No.: US 2006/0100846 A1
(43) Pub. Date: May 11, 2006

(54) Hybrid type satellite simulation system and method thereof

(76) Inventors: Sang-Uk Lee, Daejon (KR); Jae-Hoon Kim, Daejon (KR); Ho-Jin Lee, Daejon (KR); Seong-Pal Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/182,133

(22) Filed: Jul. 14, 2005

(30) Foreign Application Priority Data
Nov. 11, 2004 (KR) 10-2004-0091896

(51) Int. Cl. G06F 9/45

(52) U.S. Cl. 703/22

(57) ABSTRACT

A hybrid-type satellite simulation system and a method thereof are disclosed. The system includes: a satellite modeling unit including a satellite model and a software model having flight dynamics and space environment data; a satellite operation unit for generating a telecommand, transmitting the telecommand to the satellite simulation system, receiving simulation result as a telemetry, analyzing the simulation result and displaying the analyzed result; a simulator kernel for managing and controlling the satellite simulation system; a TCP/IP interface processing unit for performing an interface function of TCP/IP level between the simulator kernel and a satellite onboard computer; an onboard computer interface processing unit for performing an interface function between the satellite onboard computer and the TCP/IP interface processing unit; and a satellite onboard computer including flight software for controlling a satellite.

### FIELD OF THE INVENTION

The present invention relates to a hybrid type satellite simulation system and a method thereof; and, more particularly, to a hybrid type satellite simulation system for performing accurate and realistic simulation by using an interface between a simulation software including generalized satellite model and a flight dynamics and space environment model and a satellite onboard computer system or similar onboard computer hardware, and a method thereof.

### DESCRIPTION OF THE PRIOR ART

The conventional satellite simulator is typically classified to a hybrid type which is constructed with software and hardware and a software type which is constructed with only software. That is, there are the various conventional satellite simulators introduced according to a purpose of satellite simulation. Sometimes, additional satellite on ground is used for analyzing satellite anomaly.

Generally, the software type satellite simulator is easy to develop. In contrary, it is very complicated to develop the hybrid type satellite simulator including a satellite control logic implemented in an onboard computer equipped in the real satellite for simulating an onboard flight software. Accordingly, there is limitation in simulating accurate and realistic onboard flight software by using the conventional satellite simulator.

In Europe, MIL-STD-1750 or ERC-32 is used for satellite onboard simulation. The MIL-STD-1750 or the ERC-32 is a popular onboard computer system in a real satellite. Also, a process emulator has been developed for flight software which is running on MIL-STD-1750 or the ERC-32 to be run on it. Therefore, the developed process emulator has been used as a simulator simulating almost of functions of the MIL-STD-1750 and the ERC-32.

Also, there have been various conventional hybrid type satellite simulators introduced.

For example, a conventional satellite simulator has been introduced in Korea Patent application No. 2003-0013827 entitled “system for simulating communication and broadcasting satellite and method for processing telecommand and telemetry data” Mar. 5, 2003. The conventional satellite simulator is hybrid type simulator including an onboard computer system and software. The conventional satellite simulator has been used for simulating the bus hardware and payloads of the satellite.

Another conventional satellite simulator has been introduced in Japan Patent Publication No. 6-279163 entitled “satellite data simulator”. In the conventional satellite simulator, a static simulator is used for simulating generation of satellite data in order to verify functions of a ground control system.

Furthermore, another conventional satellite simulator has been introduced in U.S. Pat. No. 6,048,366 entitled “satellite simulator” issued at Apr. 11, 2000. The satellite simulator in U.S. Pat. No. 6,048,366 is a software simulator performing simulations for generating and transmitting a telecommand and performing telemetry processing. The above mentioned simulator has been widely used as a simulator tool for testing the ground controlling system with low cost.

However, it is difficult to simulate various satellite operations by using the conventional satellite simulators and also, there is limitation to simulate flight software loaded in the satellite by using the conventional satellite simulators. Therefore, the conventional satellite simulators may provide inaccurate results of simulations.

### SUMMARY OF THE INVENTION

It is, therefore, an object of the present invention to provide a hybrid type satellite simulation system and a method thereof for performing a simulation by interfacing a dynamic/static simulator of a satellite with an onboard computer system or a similar hardware by providing an interface between a satellite onboard flight software and a generalized satellite simulator.

In accordance with one aspect of the present invention, there is provided a hybrid type satellite simulation system, including: a satellite modeling unit including a satellite hardware subsystem model and a software model having flight dynamics and space environment data generalized by using object-oriented design; a satellite operating unit for generating a telecommand CMD1, transmitting the generated telecommand CMD1 to the hybrid type satellite simulation system, receiving a result of the simulation as a telemetry TLM1, analyzing the result of the simulation and displaying it; a simulator kernel unit for managing and controlling the hybrid type satellite simulation system; a TCP/IP interface processing unit for performing an interface function of Transmission Control Protocol/Internet Protocol (TCP/IP) level between the simulator kernel unit and a satellite onboard computer interface processing unit; an onboard computer interface processing unit for performing an interface function between the satellite onboard computer and the TCP/IP interface processing unit; and a satellite onboard computer including an flight software for controlling a satellite.

In accordance with another aspect of the present invention, there is provided a method for hybrid type satellite simulation, the method including the steps of: a) transmitting a telecommand CMD1, to be transmitted to a satellite, to a satellite onboard computer including a satellite flight software through a simulator kernel, a TCP/IP interface processing unit and a onboard computer interface processing unit from Simulator user interface/satellite operation system b) transmitting a satellite control command (CMD2) generated by the satellite onboard computer flight (flight software) and a command (CMD2) transmitted by the simulator user interface and the satellite operation system to the satellite modeling unit through a onboard computer interface processing unit, a TCP/IP interface processing unit and the simulator kernel; c) generating a telemetry TLM1 having a type identical to a telemetry transmitted to the satellite ground control system by the satellite onboard computer flight software based on a telemetry TLM2 generated according to a result simulated by the satellite modeling unit; and d) transmitting the generated telemetry TLM1 to a simulator user or a satellite operation system through the onboard computer interface processing unit, the TCP/IP interface processing unit and the simulator kernel.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a hybrid satellite simulation system in accordance with a preferred embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

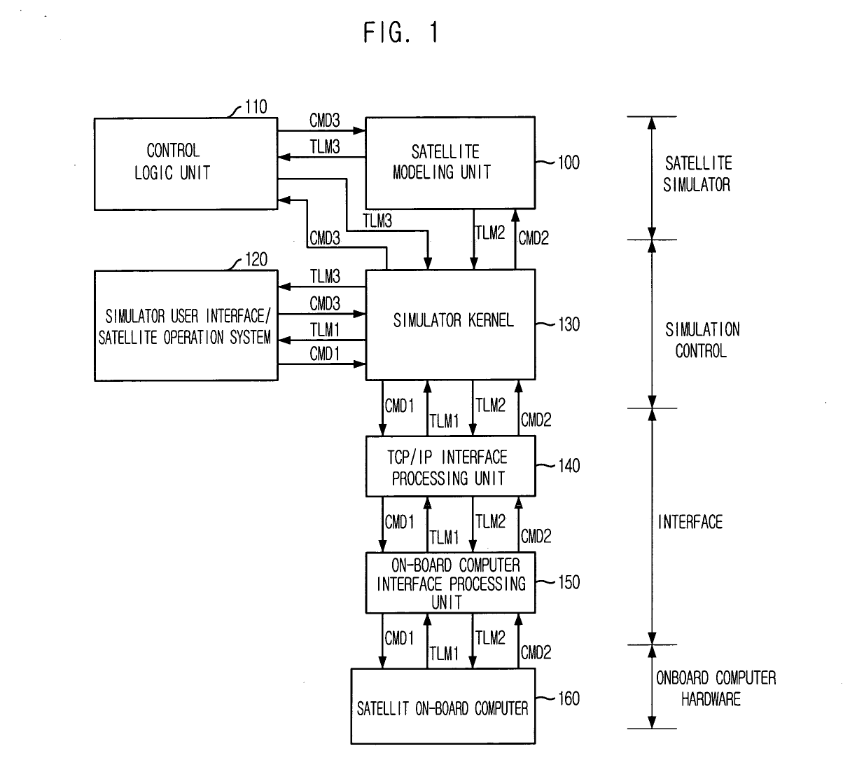

FIG. 1 is a diagram illustrating a hybrid satellite simulation system in accordance with a preferred embodiment of the present invention.

As shown in FIG. 1, the hybrid satellite simulation system includes a satellite modeling unit 100, a control logic unit 110, a simulator user interface/satellite operation system 120, a simulator kernel 130, a TCP/IP interface processing unit 140, an onboard computer interface processing unit 150 and a satellite onboard computer 160.

The satellite modeling unit 100 includes a generalized satellite model and a software model having flight dynamics and space environment data, which are modeled by using an object-oriented design methodology.

The simulator user interface/satellite operation system 120 generates a telecommand (CMD1), transmits the generated telecommand (CMD1), receives a telemetry (TLM1) as a simulation result through the simulator kernel 130, analyzes the telemetry (TLM1) and displays the analyzed result.

The simulator kernel 130 manages and controls the hybrid type satellite simulation system.

The TCP/IP interface processing unit 140 performs an interface function of a TCP/IP.

The onboard computer interface processing unit 150 performs an interface function between the TCP/IP interface processing unit 140 and the satellite onboard computer 160.

The satellite onboard computer 160 includes a flight software for controlling the satellite.

Also, the hybrid satellite simulation system of the present invention includes the control logic unit 110 for verifying a control logic to be implemented to the satellite without the satellite onboard computer.

The control logic unit 110 includes a satellite control logic to be verified and an interface with satellite modeling unit including generalized satellite hardware models, flight dynamics model of the satellite and a space environment model. The control logic unit 110 also includes an interface through the simulator kernel 130 and provides tools for dynamically testing the control logic with various conditions. If it is appropriate to use a process emulator of the satellite onboard computer 160 and a flight software, a satellite flight software can be used as the software simulator.

Meanwhile, the satellite modeling unit 100 includes satellite hardware standard models having common structural elements such as electric power switches, operation states of the electric power switches, telemetries and telecommands, various parameters of model, and a calibration parameters of input/output values. The satellite modeling unit 100 also includes a satellite model having various sensors and operators generated by hierarchically modeling the satellite hardwares as standard model and various space environment models. Furthermore, the satellite modeling unit 100 includes the generalized flight dynamics model capable of being modified according to an orbit and an attitude and status of the satellite.

The simulator kernel 130 controls simulation of satellite model and generally manages hybrid simulation tools. For generally controlling and managing, the simulator kernel 130 controls basic operations for interfacing with sub-elements of the hybrid satellite simulation system, controls the simulation, maintains a synchronization with the satellite onboard computer 160 and manages data required for the simulation.

The TCP/IP interface processing unit 140 and the onboard computer interface processing unit 150 provides an interface between the satellite mode and the flight software of the satellite onboard computer 160 for high accurate simulation. Also, the TCP/IP interface processing unit 140 allocates input/output channels of telecommands and telemetry. The onboard computer interface processing unit 150 provides interface supporting functions such as TCP/IP, RS232C, GPIB and Intermediate Frequency (IF) for interfacing between the satellite onboard computer and TCP/IP. By using the above mentioned interface supporting functions, internal interfaces of software simulation are provided for the simulator kernel.

Hereinafter, operations of the hybrid type satellite simulation system are explained in detail.

At first, a user transmits a telecommand CMD1 to the simulator kernel 130 according to identical method transmitting data to the satellite by using the satellite user interface/satellite control system 120 when the user wants to use a simulation tool through graphical user interface (GUI), the user wants to identify a state of satellite in simulation or the user wants to transmit direct control command by using real satellite control system in a ground control center. The satellite simulator kernel 130 transfers the telecommand CMD1 to the TCP/IP interface processing unit 140 according to the number of satellite onboard computers 160 for transmitting the telecommand CMD1 to the satellite onboard computer 160. In the preferred embodiment of the present invention, the number of satellite onboard computer 160 is one.

After then, the onboard computer interface processing unit 150 directly transmits the CMD1 to the satellite onboard computer 160 when the onboard computer 160 supports the TCP/IP interface. If the onboard computer 160 does not support the TCP/IP interface, the onboard computer interface processing unit 150 transmits the CMD1 by using another protocol such as Intermediate Frequency (IF).

The satellite onboard computer 160 receives the CMD1 from the onboard computer interface processing unit 150 and processes the CMD1 by using an internal logic. After processing, the satellite onboard computer 160 transmits a telecommand CMD2 to the onboard computer interface processing unit 150, where the CMD2 includes results of CMD1 processed in an internal logic and a telecommand to be transmitted to the satellite modeling unit 100.

The CMD2 is transferred to the satellite modeling unit 100 through the TCP/IP interface processing unit 140 and the simulator kernel 130. After the satellite modeling unit 140 receives the CMD2, the CMD2 is transferred to corresponding model and the result of simulation is transmitted to the satellite onboard computer 160 as a telecommand data TLM2 through the simulator kernel 130, the TCP/IP interface processing unit 140 and the onboard interface processing unit 150. The satellite onboard computer 160 process the TLM2 and uses the TLM2 as an input value of control logic. The satellite onboard computer 160 transmits results of processing the TLM2 as a telemetry TLM1 to the simulator kernel 130 through the onboard computer interface processing unit 150 and the TCP/IP interface processing unit 140.

The transmitted TLM1 is transmitted to the user such as a satellite operator or a simulator user through satellite user interface 120. Also, when the satellite operator or the simulator user transmits a command to the control logic 110 for verifying a control logic of the satellite through the simulator kernel 130 by using the hybrid satellite simulation system as a tool for testing satellite control logic, the control logic 110 generates a satellite telecommand CMD3 based on the received command and transmits the satellite telecommand CMD3 to the satellite modeling unit 100. A result of the simulation using the CMD3 as an input value is transmitted to the control logic 110 as a telemetry TLM3.

After transmitting TLM3, the TLM3 is used for processing next command or transferred to the user through the simulator kernel 130 and the satellite user interface 120.

The present invention described above can be realized as a program and recorded in a computer-readable recording medium such as a CD-ROM, a RAM, a ROM, a floppy disk, a hard disk and a magneto-optical disk.

The present invention can provide tools for accurate simulation of various satellites by eliminating drawbacks of software simulator and can be used for developing various aspects of a satellite.

The present application contains subject matter related to Korean patent application No. 2004-0091896, filed in the Korean Intellectual Property Office on Nov. 11, 2004, the entire contents of which is incorporated herein by reference.

While the present invention has been described with respect to the particular embodiments, it will be apparent to those skilled in the art that various changes and modifications may be made without departing from the scope of the invention as defined in the following claims.

What is claimed is:

1. A hybrid type satellite simulation system, comprising:
satellite modeling means including a satellite hardware model and a software model having flight dynamics and space environment data generalized by using object-oriented design;
satellite operating means for generating a telecommand CMD1, transmitting the generated telecommand CMD1 to the hybrid type satellite simulation system, receiving a result of the simulation as a telemetry TLM1, analyzing the result of the simulation, and displaying the analyzed result;
simulation controlling means for managing and controlling the hybrid type satellite simulation system;
TCP/IP interface processing means for performing an interface function of a TCP/IP level between the simulator controlling-means and a satellite onboard computer;
onboard computer interface processing means for performing an interface function between the satellite onboard computer and the TCP/IP interface processing means; and
satellite onboard computer including a flight software for controlling a satellite.

2. The hybrid type satellite simulation system as recited in claim 1, further comprising logic control means for verifying and confirming a control logic to be implemented in a satellite without the satellite onboard computer.

3. The hybrid type satellite simulation system as recited in claim 2, wherein the control logic means includes: a generalized satellite hardware model and a software model having flight dynamics data of satellite and space environment data, and an interface by using the simulator controlling means; provides a tool for dynamically testing the control logic in various conditions; and uses a satellite flight software as a software simulator when a process emulator of the satellite onboard computer and the flight software are appropriate to use, so that the verified control logic is implemented in the satellite.

4. The hybrid type satellite simulation system as recited in claim 1, wherein the satellite modeling means includes:
a satellite hardware standard model having common structural elements including electric power switches, operation states of the electric power switches, telemetries and telecommands, various parameters of model, and a calibration parameters of input/output values;
a satellite model having various sensors and operators generated by hierarchically modeling the satellite hardware standard model; various space environment models; and
a generalized flight dynamics model capable of being modified according to an orbit and a type of the satellite.

5. The hybrid type satellite simulation system as recited in claim 4, wherein the simulator controlling means includes a simulator kernel controlling a simulation of the satellite modeling means and generally managing simulation tools; controls basic operations for interfacing with sub-elements of the hybrid satellite simulation system; controls the simulation; includes an interface with sub-elements constructing the simulation tools; maintains a synchronization with the satellite onboard computer; and manages data required for the simulation.

6. The hybrid type satellite simulation system as recited in claim 5, wherein the TCP/IP interface processing means and the onboard computer interface processing means provides an interface between a satellite model and the flight software of the satellite onboard computer for high accurate simulation; allocates input/output channels of telecommands and telemetry by using the TCP/IP interface processing means; and provides an internal interface of simulator in a software by a simulator kernel through interface supporting functions including TCP/IP, RS232C, GPIB and Intermediate Frequency (IF) for interfacing between the satellite onboard computer and TCP/IP through the onboard computer interface processing means.

7. A method for hybrid type satellite simulation, the method comprising the steps of:
a) transmitting a telecommand CMD1, to be transmitted to a satellite, to a satellite onboard computer including a satellite flight software through a simulator kernel, a TCP/IP interface processing unit and a onboard computer interface processing unit from a software simulation tools including a generalized satellite hardware model, a satellite flight dynamics and a space environment model, which are designed based on an object-oriented design, from a user interface of a satellite and from an operating system;
b) transmitting a satellite control command generated by the satellite onboard computer flight software and a command CMD2 transmitted by the user interface of the satellite and the operating system to the satellite model through a onboard computer interface processing unit, a TCP/IP interface processing unit and the simulator kernel;
c) generating a telemetry TLM1 having a type identical to a telemetry transmitted to the satellite by the satellite onboard computer flight software based on a telemetry TLM2 generated according to a result simulated by the satellite model; and
d) transmitting the generated telemetry TLM1 to a satellite user or a satellite operation system through the onboard computer interface processing unit, the TCP/IP interface and the simulator kernel.

8. The method as recited in claim 7, wherein the satellite model includes:
a satellite hardware standard model having common structural elements including electric power switches, operation states of the electric power switches, telemetries and telecommands, various parameters of model, and a calibration parameters of input/output values;
a satellite model having various sensors and operators generated by hierarchically modeling the satellite hardware standard model, and various space environment models; and
a generalized flight dynamics model capable of being modified according to an orbit and a type of the satellite.
